(19) United States
(12) Patent Application Publication
(10) Pub. No.: US 2014/0160728 A1
(43) Pub. Date: Jun. 12, 2014

(54) LIGHT EMITTING APPARATUS

(71) Applicants: Hyung Kun Kim, Suwon-si (KR); Suk Ho Chung, Hwaseong-si (KR); Ho Sun Paek, Suwon-si (KR); Jeong Wook Lee, Yongin-si (KR)

(72) Inventors: Hyung Kun Kim, Suwon-si (KR); Suk Ho Chung, Hwaseong-si (KR); Ho Sun Paek, Suwon-si (KR); Jeong Wook Lee, Yongin-si (KR)

(73) Assignee: Samsung Electronics Co., Ltd, Suwon-si (KR)

(21) Appl. No.: 14/236,775

(22) PCT Filed: Aug. 17, 2011
(86) PCT No.: PCT/KR2011/006012

§ 371 Date: Feb. 3, 2014

(51) Int. Cl. F21K 99/00

(52) U.S. Cl. CPC F21K 9/56
USPC 362/84

(57) ABSTRACT

The present invention relates to a light emitting apparatus. According to one aspect of the present invention, the light emitting device comprises: a plurality of light emitting devices including a blue light emitting device emitting blue light and a UV light emitting device emitting ultraviolet light; and a wavelength conversion part arranged in the path of the light emitted from the plurality of light emitting devices, and provided with fluorescent substances to convert the wavelengths of the light emitted from the plurality of light emitting devices, wherein a fluorescent substance excited by and mixed with the blue light to obtain white light is arranged on a first area corresponding to the blue light emitting device, and at least a blue fluorescent substance is arranged on a second area corresponding to the UV light emitting device. When the light emitting apparatus according to the present invention is used, a combination of the light sources and the fluorescent substances within one module may be appropriately adopted to obtain both improved luminous efficacy and white light having a high color rendering index.

### TECHNICAL FIELD

The present disclosure relates to a light emitting device, and more particularly, to a light emitting device capable of emitting white light by using a light emitting diode (LED) as a light source.

### BACKGROUND ART

In general, as optical systems used for illumination devices or the like, fluorescent lamps and incandescent lamps have been widely used, but mercury used in fluorescent lamps has caused environmental issues. Further, optical systems according to the related art have a relatively short lifespan and efficiency thereof is relatively low. Therefore, the use of optical systems according to the related art is not effective in terms of saving power.

In connection therewith, white light emitting device efficiency has recently increased through research. A method of implementing such white light emitting devices may be classified as a scheme in which white light is implemented by using ultraviolet (UV) LEDs as light sources and allowing three primary color phosphors, three primary colors of light, to be excited, a scheme in which white light is implemented by using blue LEDs as light sources and allowing red phosphors and green phosphors to be excited, and a scheme in which white light is implemented by using blue LEDs as light sources and allowing yellow phosphors to be excited.

Among the three schemes detailed above, in the case of the scheme in which white light is implemented by using blue LEDs as light sources and allowing yellow phosphors to be excited, red light intensity may be deteriorated such that difficulties in terms of color implementation may be present. In addition, research into developing optical systems using UV LEDs, blue LEDs and phosphors has increased. However, while these schemes have excellent color implementation, efficiency thereof is degraded. Accordingly, research into white light emitting devices having excellent color rendering properties while having high efficiency is further required.

### DISCLOSURE

### Technical Problem

An aspect of the present disclosure may provide a light emitting device capable of emitting white light having high color rendering properties while having high efficiency, in a single module structure.

### Technical Solution

According to an aspect of the present disclosure,

a light emitting device may include: a plurality of light emitting elements including a blue light emitting element emitting blue light and an ultraviolet light emitting element emitting ultraviolet light; and a wavelength conversion unit disposed on a path of light emitted from the plurality of light emitting elements and including a phosphor so as to change a wavelength of light emitted from the plurality of light emitting elements such that the phosphor of a color excited by and mixed with the blue light so as to obtain white light is provided in a first region corresponding to the blue light emitting element, and at least a blue phosphor is provided in a second region corresponding to the ultraviolet light emitting element.

The first region of the wavelength conversion unit may include a yellow phosphor.

In this case, the second region of the wavelength conversion unit may further include a red phosphor and a green phosphor.

The first region of the wavelength conversion unit may include a red phosphor and a green phosphor.

In this case, the first region of the wavelength conversion unit may further include a yellow phosphor.

The second region of the wavelength conversion unit may only include a blue phosphor.

The wavelength conversion unit may have a form of a film.

The wavelength conversion unit may be disposed such that the first and second regions have respective lens shapes.

Light emitted using the blue phosphor may have a light wavelength longer than that of light emitted from the blue light emitting element.

Light emitted using the blue phosphor may have a full width at half maximum greater than that of light emitted from the blue light emitting element.

An amount of the blue light emitting elements may be greater than that of the ultraviolet light emitting elements.

A ratio of the number of the blue light emitting elements to the number of the ultraviolet light emitting elements may be 1:1.

In this case, the blue light emitting elements and the ultraviolet light emitting elements may be arrayed to alternate with each other.

According to an aspect of the present disclosure,

a light emitting device may include: a plurality of light emitting elements including a blue light emitting element emitting blue light and an ultraviolet light emitting element emitting ultraviolet light; and a wavelength conversion unit formed on a path of light emitted from the plurality of light emitting elements and including a blue phosphor providing a wavelength of light at least longer than, or a full width at half maximum at least greater than, that of light emitted from the blue light emitting element.

The wavelength conversion unit may further include a yellow phosphor.

The wavelength conversion unit may further include a red phosphor and a green phosphor.

### Advantageous Effects

As set forth above, according to exemplary embodiments of the present disclosure, when a light emitting device is used, a combination of a light source and a phosphor may be appropriately employed to a single module, whereby light emission efficiency may be improved and white light having high color rendering properties may be obtained.

### DESCRIPTION OF DRAWINGS

FIG. 1 is a cross-sectional view of a light emitting device according to an embodiment of the present disclosure and

FIG. 2 illustrates a detailed structure of an RGB phosphor region shown in FIG. 1;

FIG. 3 is a cross-sectional view schematically illustrating a light emitting device according to a modified example of FIG. 1;

FIG. 4 is a cross-sectional view schematically illustrating a light emitting device according to another embodiment;

FIG. 5 is a simulation graph illustrating light intensity according to a wavelength of light obtained through a combination of a blue light emitting element and a yellow phosphor, and an ultraviolet light emitting element and blue, red and green phosphors with reference to FIGS. 1 to 4; and

FIG. 6 is a cross-sectional view of a light emitting device according to another embodiment, and FIG. 7 is a simulation graph illustrating intensity of light obtained by the light emitting device of FIG. 6.

### MODE FOR INVENTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

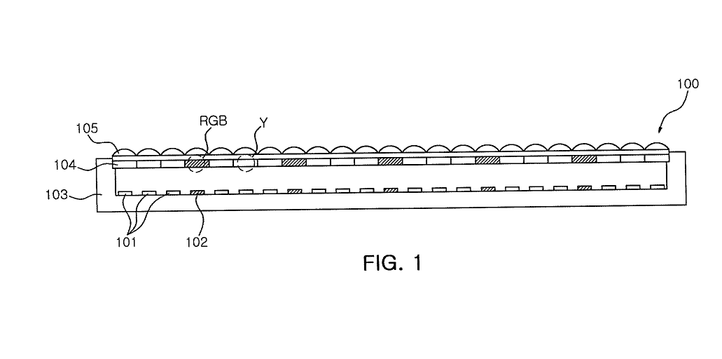

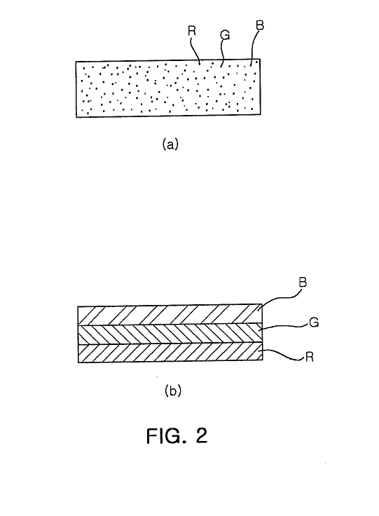

FIG. 1 is a cross-sectional view of a light emitting device according to an embodiment of the inventive concept and FIG. 2 illustrate a detailed structure of an RGB phosphor region shown in FIG. 1.

With reference to FIG. 1, a light emitting device 100 according to an embodiment includes a plurality of light emitting elements 101 and 102, and a wavelength conversion unit 104 may be provided in an upper portion thereof. The plurality of light emitting elements 101 and 102 may be formed using light emitting diodes (LEDs), and may include a blue light emitting element 101 and an ultraviolet light emitting element 102 emitting different wavelengths of light. In the present embodiment, a ratio of the number of the blue light emitting elements 101 to the number of ultraviolet light emitting elements 102 may be 3:1. The structure in which the blue light emitting element 101 and the ultraviolet light emitting element 102 are both used may be applied to use relatively high combinational efficiency and excellent color rendering combination at the time of performing a combination with a phosphor, as will be described below. The blue light emitting element 101 and the ultraviolet light emitting element 102 may be disposed in an inner portion of a housing 103, and although not illustrated in detail in FIG. 1, may be mounted on a substrate having a wiring structure.

The wavelength conversion unit 104 may have a structure in which a phosphor is included so as to emit a different wavelength of light excited by light emitted from the plurality of light emitting elements 101 and 102, and may be employed in a form of a film as illustrated in FIG. 1. In the case of the present embodiment, the wavelength conversion unit 104 may be divided into two regions, and in detail, may include a first region Y in a position thereof corresponding to the blue light emitting element 101 and a second region RGB in a position thereof corresponding to the ultraviolet light emitting element 102. The first region Y of the wavelength conversion unit 104 may include a yellow phosphor emitting yellow light excited by blue light emitted by the blue light emitting element 101 and may emit white light through a combination of the yellow light and the blue light with each other. In the case of a scheme in which white light is obtained through the combination of the blue light emitting element 101 and the yellow phosphor, relatively high light emission efficiency may be provided. Meanwhile, since white light obtained through the scheme as above has a problem in that color rendering properties are not relatively high, the scheme in which a light emitting element and a phosphor exhibiting different colors are combined may be additionally applied to in a single light emitting device 100 so as to compensate therefor.

The second region RGB of the wavelength conversion unit 104 may include blue, red and green phosphors such that white light excited by ultraviolet light emitted from the ultraviolet light emitting element 102 may be emitted therefrom. In the case of the scheme in which white light is obtained by the combination of the ultraviolet light emitting element 102 and the RGB phosphor, light emission efficiency may be relatively low, but color rendering properties of white light may be supplemented with the combination of the blue light emitting element 101 and the yellow phosphor as described above. In detail, a RGB section having relatively low light intensity in the white light obtained through the combination of the blue light emitting element 101 and the yellow phosphor may be supplemented with the combination of the ultraviolet light emitting element 102 and the RGB phosphor. In further detail, when a wavelength of light emitted using the blue phosphor provided in the second region RGB is longer than a wavelength of light emitted from the blue light emitting element 101, white light having relatively high color rendering properties, which may not be only obtained through a combination of the blue light emitting element 101 and the yellow phosphor may be effectively provided. In the case of a spectrum of light emitted using a blue phosphor, in terms of high color rendering properties, the spectrum of light emitted using a blue phosphor may have a full width at half maximum greater than that of light emitted from the blue light emitting element 101. In order to effectively implement the combination of the two elements as above, the present embodiment provides the case in which the wavelength conversion unit 104 is divided into two regions having different phosphors. On the other hand, as shown in FIG. 2, a blue phosphor, a red phosphor and a green phosphor may be mixed with each other as shown in FIG. 2A, or may be separately formed to be stacked as shown in FIG. 2B. In the case of a stacking scheme, the sequence in which blue, red and green phosphors are stacked may be appropriately changed, unlike FIG. 2B.

Although it is not necessarily required in the present embodiment, a lens-shaped optical unit 105 may be formed in an upper portion of the wavelength conversion unit 104, and as illustrated in FIG. 1, respective lenses may be disposed in locations corresponding to regions in which the plurality of light emitting elements 101 and 102 are disposed. In this case, in terms of a process, the wavelength conversion unit 104 may be appropriately formed through a method in which a film including a phosphor is printed on the optical unit 105, or the like.

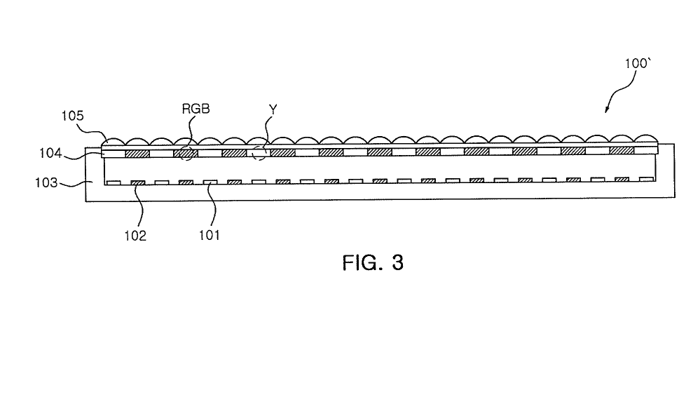

FIG. 3 is a cross-sectional view schematically illustrating a light emitting device according to a modified example of FIG. 1. A light emitting device 100′ according to an embodiment with reference to FIG. 3 may have substantially the same structure as that of the foregoing embodiment, but a ratio of the number of the blue light emitting elements 101 to the number of ultraviolet light emitting elements 102 may be 1:1. In this case, the blue light emitting elements 101 and the ultraviolet emitting elements 102 may be arrayed to alternate with each other. Therefore, the ratio of the first regions Y and the second regions RGB in the wavelength conversion unit 104 may be changed to correspond thereto. As such, the ratio of the number of the blue light emitting elements 101 and the ultraviolet light emitting elements 102 may be appropriately controlled according to the color rendering properties of white light required to be suitable therefor.

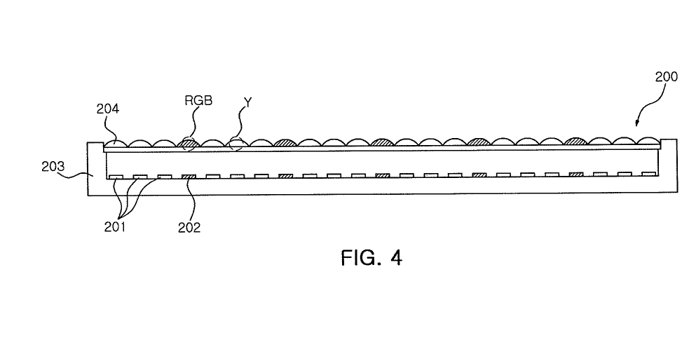

FIG. 4 is a cross-sectional view schematically illustrating a light emitting device according to another embodiment. A light emitting device 200 according to an embodiment may include a plurality of light emitting elements 201 and 202, similarly to the light emitting device 100 of FIG. 1, and a wavelength conversion unit 204 may be provided in an upper portion thereof. The plurality of light emitting elements may be a blue light emitting element 201 and an ultraviolet light emitting element 202, and in locations of the wavelength conversion unit 204 corresponding thereto, a first region Y including a yellow phosphor and a second region RGB including red and green phosphors may be formed. In the case of the present embodiment, the wavelength conversion unit 204 may be integrated with a lens shaped optical unit. For example, the wavelength conversion unit 204 may be formed to have a lens-integrated structure in a ceramic sheet form, and by using such a structure, the size of the light emitting device 200 may be further reduced so as to be used as an ultra-slim white illumination device.

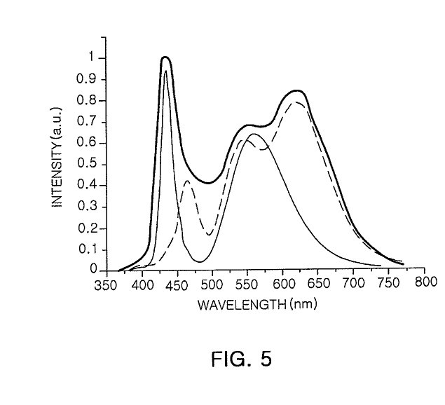

FIG. 5 is a simulation graph illustrating light intensity according to a wavelength of light obtained through a combination of a blue light emitting element and a yellow phosphor, and an ultraviolet light emitting element and blue, red and green phosphors, described above with reference to FIGS. 1 to 4. In FIG. 5, a solid line denotes light obtained through the combination of the blue light emitting element and the yellow phosphor and a dotted line denotes light obtained through the combination of the ultraviolet light emitting element and the blue, red and green phosphors . A thick solid line denotes a result in which the light is mixed through the two combinations as above. With reference to FIG. 5, light obtained through the combination of the blue light emitting element and the yellow phosphor may have two peak wavelengths of light in blue and yellow, and light obtained through the combination of the ultraviolet light emitting element and the blue, red and green phosphors is mixed therewith, whereby it can be appreciated that spectra of white light may be various. In detail, with the supplementation with spectra in a red region and a blue region having a relatively long wavelength of light, color rendering properties of white light may be relatively excellent.

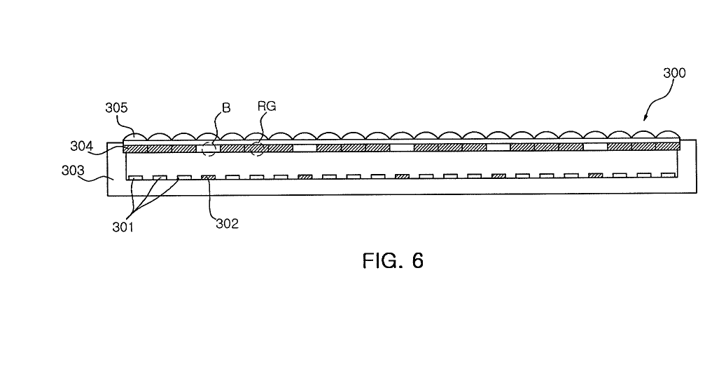

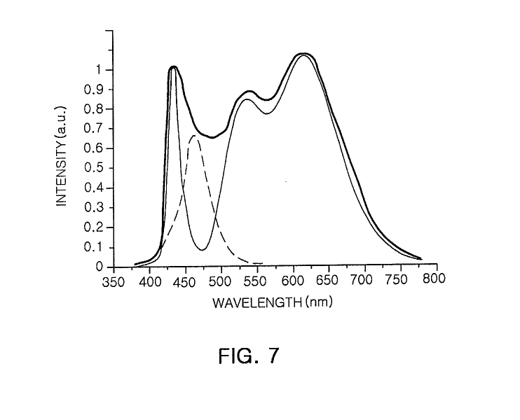

Although the foregoing embodiments only provide cases in which the blue light emitting element and the yellow phosphor, and the ultraviolet light emitting element and the blue, red and green phosphors are combined, phosphors may be used in a different scheme as long as a combination thereof can obtain high efficiency and high color rendering properties. FIG. 6 is a cross-sectional view of a light emitting device according to another embodiment, and FIG. 7 is a simulation graph illustrating intensity of light obtained by the light emitting device of FIG. 6.

With reference to FIG. 6, a light emitting device 300 according to an embodiment includes a plurality of light emitting elements 301 and 302, similarly to that of the foregoing embodiment, and a wavelength conversion unit 304 may be provided in an upper portion thereof. In addition, the plurality of light emitting elements may be a blue light emitting element 301 and an ultraviolet light emitting element 302. In the case of the present embodiment, in a location of the wavelength conversion unit 304 corresponding to the blue light emitting element 301, a first region RG including a red phosphor and a green phosphor may be disposed, and in a location of the wavelength conversion unit 304 corresponding to the ultraviolet light emitting element 302, a second region B including a blue phosphor may be disposed. In this case, the first region RG may further include a yellow phosphor in addition to the red and green phosphors, and in order to increase a color rendering index, the blue phosphor included in the second region B may be formed of a material capable of emitting light having a wavelength of light longer than that of blue light emitted from the blue light emitting element 301.

In FIG. 7, a solid line denotes light obtained through a combination of the blue light emitting element and the red and green phosphors, and a dotted line denotes light obtained through a combination of the ultraviolet light emitting element and the blue phosphor. A thick solid line denotes a result in which the light is mixed through the two combinations as above. As illustrated in FIG. 7, in the case of white light obtained by combining the blue light emitting element with the red and green phosphors and combining the ultraviolet light emitting element with the blue phosphor, relatively excellent light emission efficiency may be exhibited in red and green spectral regions, whereby it can be appreciated that a long wavelength region of blue light may be supplemented with the blue phosphor. Accordingly, in the light emitting device 300 using the combination of the blue light emitting element and the red and green phosphors, and the ultraviolet light emitting element and the blue phosphor, relatively high efficiency and high color rendering properties maybe obtained simultaneously with each other, similarly to the foregoing embodiment.

While exemplary embodiments have been shown and described above, it will be apparent to those skilled in the art that modifications and variations could be made without departing from the spirit and scope of the present disclosure as defined by the appended claims.

1. A light emitting device comprising:
a plurality of light emitting elements including a blue light emitting element emitting blue light and an ultraviolet light emitting element emitting ultraviolet light; and
a wavelength conversion unit disposed on a path of light emitted from the plurality of light emitting elements and including a phosphor so as to change a wavelength of light emitted from the plurality of light emitting elements such that the phosphor of a color excited by and mixed with the blue light so as to obtain white light is provided in a first region corresponding to the blue light emitting element, and at least a blue phosphor is provided in a second region corresponding to the ultraviolet light emitting element.

2. The light emitting device of claim 1, wherein the first region of the wavelength conversion unit includes a yellow phosphor.

3. The light emitting device of claim 2, wherein the second region of the wavelength conversion unit further includes a red phosphor and a green phosphor.

4. The light emitting device of claim 1, wherein the first region of the wavelength conversion unit includes a red phosphor and a green phosphor.

5. The light emitting device of claim 4, wherein the first region of the wavelength conversion unit further includes a yellow phosphor.

6. The light emitting device of claim 4, wherein the second region of the wavelength conversion unit only includes a blue phosphor.

7. The light emitting device of claim 1, wherein the wavelength conversion unit has a form of a film.

8. The light emitting device of claim 1, wherein the wavelength conversion unit is disposed such that the first and second regions have respective lens shapes.

9. The light emitting device of claim 1, wherein light emitted using the blue phosphor has a light wavelength longer than that of light emitted from the blue light emitting element.

10. The light emitting device of claim 1, wherein light emitted using the blue phosphor has a full width at half maximum greater than that of light emitted from the blue light emitting element.

11. The light emitting device of claim 1, wherein an amount of the blue light emitting elements is greater than that of the ultraviolet light emitting elements.

12. The light emitting device of claim 1, wherein a ratio of the number of the blue light emitting elements to the number of ultraviolet light emitting elements is 1:1.

13. The light emitting device of claim 12, wherein the blue light emitting elements and the ultraviolet light emitting elements are arrayed to alternate with each other.

14. A light emitting device comprising:
a plurality of light emitting elements including a blue light emitting element emitting blue light and an ultraviolet light emitting element emitting ultraviolet light; and
a wavelength conversion unit disposed on a path of light emitted from the plurality of light emitting elements and including a blue phosphor providing a wavelength of light at least longer than, or a full width at half maximum at least greater than, that of light emitted from the blue light emitting element.

15. The light emitting device of claim 14, wherein the wavelength conversion unit further includes a yellow phosphor.

16. The light emitting device of claim 14, wherein the wavelength conversion unit further includes a red phosphor and a green phosphor.

17. The light emitting device of claims 5, wherein the second region of the wavelength conversion unit only includes a blue phosphor.
